(19) United States
(12) Patent Application Publication
(10) Pub. No.: US 2020/0183517 A1
(43) Pub. Date: Jun. 11, 2020

(54) DATA COMMUNICATION METHOD BETWEEN TWO ELECTRONIC DEVICES BY USING NEGATIVE ELECTRIC WITH UNIPOLAR WAVE FREQUENCY

(71) Applicant: Osman COLAKOGLU, Istanbul (TR)

(72) Inventor: Osman COLAKOGLU, Istanbul (TR)

(21) Appl. No.: 16/790,025

(22) Filed: Feb. 13, 2020

Related U.S. Application Data
(63) Continuation-in-part of application No. 16/426,731, filed on May 30, 2019, now Pat. No. 10,599,876.
Application No. 16/426,731 is a continuation-in-part of application No. 15/915,612, filed on Mar. 8, 2018, now Pat. No. 10,325,571.
Application No. 15/915,612 is a continuation-in-part of application No. 14/122,053, filed on Apr. 25, 2014, now Pat. No. 9,939,886.

(30) Foreign Application Priority Data
May 24, 2011 (TR) 2011/05036

(51) Int. Cl. G06F 3/044; G06F 3/0354; G06F 3/038; G06F 3/041

(52) U.S. Cl. CPC G06F 3/044; G06F 3/03545; G06F 2203/04104; G06F 3/04162; G06F 3/0383

(57) ABSTRACT

A wireless data communication method wherein the data is transferred after the connection of the first device and the second device that can store information and/or generate information, wherein at least one of the devices can transfer the data to the other device by using negative electricity with unipolar wave frequency.

### CROSS-REFERENCE TO RELATED APPLICATIONS

The present application is a continuation-in-part of U.S. patent application Ser. No. 16/426,731, filed on May 30, 2019, presently pending. U.S. patent application Ser. No. 16/426,731 is a continuation-in-part of U.S. patent application Ser. No. 15/915,612, filed on Mar. 8, 2018, which issued as U.S. Pat. No. 10,325,571 on Jun. 18, 2019. U.S. patent application Ser. No. 15/915,612 is a continuation-in-part of U.S. patent application Ser. No. 14/122,053, filed on Nov. 25, 2013, which issued as U.S. Pat. No. 9,939,886 on Apr. 10, 2018.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### 1. Field of the Invention

The present invention relates to a method enabling wireless sharing of files or data via touch surface between electronic devices that can store information and/or generate information.

The present invention especially relates to a data transfer method after the connection of the electronic devices (for example a tablet and a stylus) that can store information and/or generate information wherein at least one of the devices can transfer the data to the other device by using negative electricity with unipolar wave frequency.

### 2. Description of Related Art Including Information Disclosed Under 37 CFR 1.97 And 37 CFR 1.98

There are two methods, wired and wireless, of data sharing between electronic devices. In the data transmission via cables, there are adverse circumstances such as the possibility of the cables being lost, not available to the user, and not compatible with the device such as computers, etc. to which the data will be transmitted. Another problem is the failure to establish data transmission when the cable is deformed.

Another problem encountered in the current state of the art is that there are risks such as the computer not recognizing the external apparatus when external devices such as flash memory, memory card, etc. are used.

There is the breakdown possibility of the plug-in-out apparatus (cable, flash memory, memory card, etc.) during the plugging in and out thereof to and from the device such as computers, etc. to which the data will be communicated. Similarly, corresponding parts of the cameras, mobile phones, etc. to which the data will be transmitted can be damaged. Moreover, there is a high risk of experiencing data loss in the memory cards or flash memories during the wrong use of plug-in-out apparatus.

Location of the relevant memory card cannot be known to all of the users when using media tools such as cameras, mobile phones, etc. and there is a risk of loss while plugging and removing the memory card, therefore, there is a risk of data loss.

During the wireless transmissions (such as the data transfer which will be carried out only with Bluetooth) there is a risk of sending the data to a different user.

Bluetooth data sharing method used in the current state of the art can also be employed. However, this method is manual. Primarily, devices should be manually introduced to each other for communication between them. Data communication by means of this method takes longer and thus is more difficult. This is because the user must introduce the devices to each other and find the location of files on the computer.

Users may have difficulty in locating the relevant folder in the operating system if the computer doesn't automatically show the removable devices on the screen during the plugging in of these devices. For instance, let's say that a user goes to a printing centre and the employees of the centre use table-shaped computers. And the user wants the birthday photos taken at their home to be printed. In this case, the duration for the activation of the Bluetooth feature of the camera and introduction of this camera to the computer is 5 to 10 minutes for a person familiar with these operations. This situation will cause the job of the user to take longer or not preferring data import from the cameras.

In prior art, the location of the stylus is automatically determined according to the position where signal sends. But in order to determine the direction of the stylus according to the tablet computer, the stylus must include at least one compass sensor or both of them (the tablet computer and the stylus) have to include compass sensors. Otherwise, the screen image of the other device placed on the screen will be independent of the device. The user will have to set this direction by realizing a second action. In prior art, it is not disclosed a method which control and modify these data signals between a first device and a second device by means of the compass sensor, the inclination sensor and the pressure sensor which are placed on one or both of the first and second devices.

In conclusion, an improvement in the relevant technical field rendered necessary due to the negative aspects mentioned above and insufficiency of the current solutions.

### OBJECT OF THE INVENTION

The invention is developed by being inspired from existing conditions and seeks to solve the above mentioned drawbacks.

The main object of the present invention is to improve a data transfer method after the connection of the electronic devices (for example a tablet and a stylus) that can store information and/or generate information wherein one of the devices can transfer the data to the other device by using negative electricity with unipolar wave frequency.

Another object of the present invention is to use analog and/or digital coding in this unipolar wave frequency depending on the type of data.

Another object of the present invention is that, the second device can receive modulated data at this frequency used at the point where the first device touches the touch surface of the second device. The frequency can be transmitted by negative electrical pulses, wherein the data being encoded with on/off and/or voltage changes.

Another object of the present invention is that, at the point where the first device touches the touch surface of the second device is a conductive end. With this conductive end, data signals are sent from the first device to the second device. It is likewise possible to measure negative electricity on the touch surface by the first device.

Therefore, it is possible to transmit data from the second device to the first device by the same technique. Again at this point, data can be transmitted to the counter device over the same frequency. This frequency can also be used as a unipolar wave to use only negative electricity. Analog and/or digital coding may be used depending on the type of data at this unipolar wave frequency. The first device (for example a stylus) can receive the data modulated by measuring the negative electricity at the frequency used at the point where the first device touches the touch surface of the second device. The frequency can be transmitted by negative electrical pulses, that is, data being encoded with open, closed and/or voltage changes.

The object of the present invention is to improve a method which is applied between a first device as a stylus and a second device as a tablet computer with capacitive touch panel, wherein it is used to transmit mutual data signals using negative electrical signals with unipolar wave frequency, and to control and modify these data signals by means of the compass sensor, inclination sensor and pressure sensor which are placed on one or both of the devices.

The object of the present invention is to enable quick wireless sharing of files or data between electronic devices that can store information and/or generate information.

Another object of the present invention is to eliminate the need for cables used in the current state of the art thanks to the wireless connection of the electronic devices with each other.

Another object of the present invention is to eliminate cable incompatibility between different models of electronic devices as cable is not required for connection.

Another object of the present invention is to prevent any deformation of the parts of removable devices as cable is not required for connection.

Another object of the present invention is to provide a means for users of all ages thanks to the easy use thereof.

Another object of the present invention is to enable even the users who do not know a foreign language sending data thanks to the simple transfer mode provide.

Another object of the present invention is to eliminate the problem of waste of time thanks to the devices quickly establishing communication with each other.

Another object of the present invention is to facilitate data communication of increasingly used electronic devices of today such as tablet computers with capacitive multi-touch panel and a stylus with each other, making this method functional.

### BRIEF SUMMARY OF THE INVENTION

The present invention for fulfilling the above-described objects is a method of data communication via a touch surface such as to enable wireless data communication between a first device and a second device, the method comprising:

turning on the first device and the second device, the first device capable of data generation and/or data storage, the second device capable of data generation and/or data storage, said second device is electrically contacted with a capacitive multi-touch panel with a capacitive multi-touch surface;

after performing the data transmission that the user wishes to perform, the user disconnects the connection of the first device with the second device;

wherein the method further comprises turning on the first device and sending the signal to a conductor tip;

placing the first device on the capacitive multi-touch surface contacted with the second device;

sending the signals defining the identification and position information of the first device on the capacitive multi-touch surface by the conductor tip;

receiving the signals sent by the conductor tip on the capacitive multi-touch surface;

sending of the information from the second device to the first device, containing the confirmation that the identity and location of the first device is received and it is ready to receive data; and transferring the data after the connection of the first the second devices that can store information and/or generate information, wherein at least one of the devices can transfer the data to the other device by using negative electricity with unipolar wave frequency.

In a preferred embodiment of the present invention, the data is transferred by using capacitive multi-touch panel from the first device to the second device by negative electric signals with unipolar wave frequency or from the second device to the first device by negative electric signals with unipolar wave frequency.

In a preferred embodiment of the present invention, the data is transferred by using the analog and/or digital coding in said unipolar wave frequency depending on the type of data.

In a preferred embodiment of the present invention, the second device can receive modulated data at said frequency used at the point where the first device touches the touch surface of the second device.

In a preferred embodiment of the present invention, the frequency can be transmitted by negative electrical pulses, wherein the data being encoded with on/off and/or voltage changes.

In a preferred embodiment of the present invention, the first device is a stylus with a conductor tip and the second device is a tablet computer with a capacitive multi-touch panel, the data is sent from the tablet computer to the stylus by means of a dedicated capacitive area on the capacitive multi-touch panel that corresponds to the bottom of the stylus, wherein it touches the capacitive multi-touch panel.

The structural and the characteristic features and all advantages of the invention will be understood more clearly with the detailed description written by referring to the following figures and therefore, the evaluation needs to be done by taking these figures and the detailed description into consideration.

### BRIEF DESCRIPTION OF THE SEVERAL VIEWS OF THE DRAWINGS

FIG. 1 is a representational view of the elements used in the data communication method via touch surface according to the invention.

FIG. 2 is a flow diagram showing the process steps of the data communication method via touch surface according to the invention.

FIG. 3 is a schematic view showing the data communication between the first device and the second device of the data communication method via touch surface according to the invention.

FIG. 4 is a representational view of the data communication method between a stylus and a tablet computer.

FIG. 5 shows the operating principle of a compass sensor on the first device.

FIG. 6 shows the simultaneous operation of the inclination sensor and the compass sensor.

FIG. 7 is a schematic view showing the frequency of the electricity used only in the form of negative electricity.

FIG. 8 is a schematic view showing the digital coding of frequency.

FIG. 9 is a schematic view showing the analogue coding of frequency.

FIG. 10 is a schematic view of a first example showing the analog and digital coding of frequency.

FIG. 11 is a schematic view of a second example showing the analog and digital coding of frequency.

FIG. 12 is a a representational view of the data communication method between a stylus and a tablet computer by negative electricity with unipolar wave frequency.

FIG. 13 is a representational view of the data communication method between a stylus and a tablet computer showing the capacitive area.

FIG. 14 is a a representational algorythm of the processes that devices use to transmit data to the other device.

FIG. 15 is a a representational algorythm of the processes that devices use to receive data from the sending device.

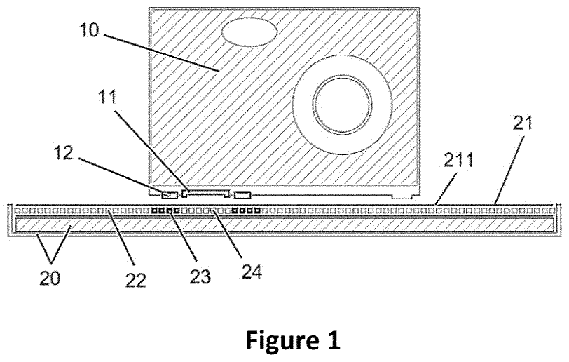

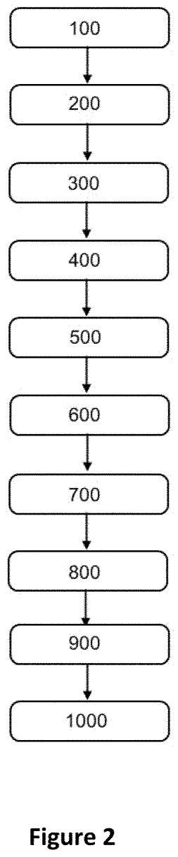

### DESCRIPTION OF REFERENCE NUMERALS

10. First device
11. Photo sensor
12. Conductive frame
13. Processor
14. Circuit board
15. Electrical supply
16. Conductor tip
17. Light sensor
18. Compass sensor
19. Inclination sensor
101. Pressure sensor
102. Dedicated capacitive area
20. Second device
21. Capacitive multi-touch panel
211. Capacitive multi-touch surface
212. Graphic area
2121. Input chart
22. Image forming units
23. Image blanking units
24. Data transfer units
25. Circuit board
26. Processor
27. Display units
28. Compass sensor
29. Inclination sensor
30. Electrical supply

### DESCRIPTION OF THE PROCESS STEPS

100. Turning the first device (10) and the second device (20) on
200. Turning the first device (10) on for sending commands triggering the second device (20) as negative electrical signals through conductive frame part (12)
300. Placing the first device (10) on the capacitive multi-touch surface (211) contacted with the second device (20)
400. Sending the signals enabling the detection of the identity and position information of the first device (10) on the multi-touch panel (21) to the second device (20) through conductive frame (12) over capacitive multi-touch surface (211)
500. Reception of the signals sent over capacitive multi-touch surface (211) through the conductive frame (12) by the second device (20)
600. Blanking of the corresponding area of the second device (20) located below the conductive frame (12), for image blanking unit (23) located below capacitive multi-touch surface (211) sending signal
700. Sending of the information from the second device (20) to the first device (10), containing the identity information of the second device (20) and the confirmation that the identity and location of the first device (10) is received and it is ready to receive data, by means of light signals through switching the data transfer units (24) corresponding to the middle of image blanking units (23) on and off
800. Identification by the first device (10) through converting the light signals emitted by the data transfer units (24) into data by means of photo sensor (11) thereof that the second device (20) recognized it and is ready to receive data
900. Transferring the data by using capacitive multi-touch panel (21) from the first device (10) to the second device (20) or from the second device (20) to the first device (10) depending on the preference of user
1000. Disconnection of the first device (10) from the second device (20) after the user performs the desired data transfer

Scaling of drawings is not absolutely required and details, which are not needed for understanding the present invention, can be neglected. Furthermore, elements, which are at least substantially identical or have at least substantially identical functions, are indicated with the same number.

### DETAILED DESCRIPTION OF THE INVENTION

In this detailed description, preferred process steps of the data communication via multi-touch surface according to the invention are explained only for a better understanding of the subject matter.

Data communication according to the present invention using multi-touch surface comprises the following: first storage device (10); photo sensor (11); conductive frame (12); and second storage device (20) on which multi-touch panel (21) comprising multi-touch surface (211) is provided.

Capacitive multi-touch panel (21) is provided on the second device (20) and contacted electrically to the second device (20). Here the term multi refers to multi-touch panel (21) being sensitive to a plurality of electronic devices. Capacitive multi-touch panel (21) provides data input to any electronic device by means of touching operation, wherein it comprises capacitive touch surface (211) preferably allowing usage by the finger. Said panel (21) can be any other type of panel having the multi-touch feature and being sensitive to negative or positive electricity.

The image on the capacitive multi-touch panel (21) is provided by means of the image forming unit (22), image blanking unit (23) and data transfer units (24), all of which are located just below the capacitive multi-touch surface (211) and preferably composed of LEDs. Said units (22, 23, 24) are preferably LED, wherein the image on the capacitive multi-touch panel (21) can also be provided by means of a projector, led, a plasma or LCD screen.

The first device (10) and the second device (20) are characterized in that both can generate and store data and at least one of the two (10, 20) has a capacitive multi-touch surface (211). Therefore, the first device (10) and the second device (20) may also be a mouse or keyboard, as well as telephone, a tablet PC, camera or a hard disk such that at least one of the two said devices to be provided with data communication comprise capacitive multi-touch surface (211). In this detailed description operations performed will be described with the camera (10) as the first device (10) and the table-shaped computer (20) as the second device (20).

Conductive frame (12) is made of metallic material and surrounds the photo sensor (11). Conductive frame (12) is used to transmit data from the camera (10) to the table-shaped computer (20) by means of negative electricity. Photo sensor (11) is used to measure light intensity of the data transfer units (24) provided in the table-shaped computer (20).

Data communication method via multi-touch surface according to the invention takes place as follows. First, the user turns the camera (10) and the table-shaped computer (20) on by means of pressing on the on and off buttons provided thereon (100). When the first device (10) is turned on it sends signal to the conductive frame (12). Then, the user places the camera (10) on the touch panel (21) such that the conductive metal frame (12) stays on the capacitive multi-touch surface (211) of the capacitive multi-touch panel (21) (300). The camera (10) starts to send the signals, required for its introduction to the table-shaped computer (20), to the touch panel (21) through conductive frame (12) and using negative electricity (400). The computer (20) starts to receive said signals by means of the capacitive multi-touch panel (21) and acquires information comprising identity of the camera (10) and location thereof on the capacitive multi-touch surface (211) (500). Now, the information regarding the camera (10) is received by the computer (20). In this case, the computer (20) should start to communicate with the camera (10). Thus, the computer (20) blanks the corresponding area below the conductive metal frame (12) for the photo sensor (11) provided in the camera (10) by preventing light emission of the image blanking units (23) provided in the touch panel (21) (600). With this process, the computer (20) starts to send signal to the photo sensor (11) by means of the data transfer units (24) provided in the middle of the blanked area for transferring data to the camera (10) (700). These sent signals comprise information confirming that relevant information about the camera (10) is received and the computer (20) is ready to receive data. At this point, actually, the difficult and time consuming introduction process, i.e. introduction of the camera (10) to the table-shaped computer (20) is obtained. Now, at this moment, the user may choose a method for data communication between the camera (10) and the table-shaped computer (20) or proceed with the already chosen method. After the introduction process of the devices (10, 20) to each other, the user may maintain the connection between the camera (10) and the table-shaped computer (20) by means of light and electrical signals as in the introduction process or may prefer to carry out communication by means of radio frequency. In the case that the user prefers to perform the communication via radio frequency, he or she may choose communication via Bluetooth (wireless connection for short distances) or Wi-Fi (wireless connection). Then, the user can perform desired operations via multi-touch surface (211) or a button or buttons provided on the camera (10) (900).

User requests such as sending photos, videos, etc., sending and receiving signal by means of light signals take place as follows: sending of the signal from the camera (10) to the table-shaped computer (20) proceed from the conductive metal frame (12) towards the capacitive multi-touch surface (211) while sending of the signal from the table-shaped computer (20) to the camera (10) proceed from the data transfer units (24) towards the photo sensor (11).

Upon completion of the data sending and receiving processes, the user performs disconnection process of the camera (10) from the computer (20) (1000). This process can be carried out by pressing the on off buttons of either the camera (10) or the table-shaped computer (20) or by removing the camera (10) from the capacitive multi-touch surface (211) (1000).

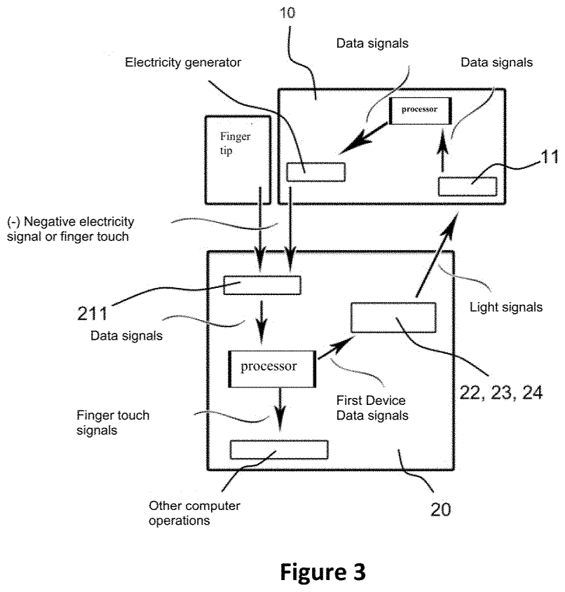

In FIG. 3, a schematic view showing some process steps of the data communication method via touch surface according to the invention and data communication between the first device (10) and the second device (20) is given. First, the first and the second device (10, 20) are turned on. Then, energy is given to the conductive frame (12) by means of the electricity generator of the first device (10). As shown in FIG. 3, the first electronic device (10) is placed on the capacitive multi-touch surface (211). The first device (10) sends data signals to the second device (20) through the conductive frame (12) by means of negative electrical signals thanks to the capacitive feature of the capacitive multi-touch surface (211). Said data signals is processed within the processor of the second device (20) and said processor (20) generates data comprising information confirming that the second device (20) recognized the first device and it is ready to receive data. Data transfer units (24) send this information to the photo sensor (11) by means of light signals. Data signals received by the photo sensor (11) are sent to the processor of the first device (10). Processor receives these data signals and generates the information that it is now ready to send data. After these operations, content of the first device (10) is displayed on the capacitive multi-touch surface (211). List of data types (photo, video, etc.) contained within the first device (10) is displayed right next to the said device.

Then, the user moves their finger on the capacitive surface (211) for arranging the content displayed on the capacitive multi-touch surface (211). Capacitive surface (211) detects touching of the finger and the processor of the second device (20) performs computer operations according to the requests of the user.

The most important point in the data communication via capacitive multi-touch surface (211) is that the camera (10) is introduced to the table-shaped computer (20) in an easy manner and the data desired to be sent from the camera (10) to the table-shaped computer (20) is shown with respect to the position of the camera (10) on the table-shaped computer (20). For instance, let's say that a table-shaped computer (20) is available and 2 cameras (10) are placed on table-shaped computer (20). By this way, content for each camera (10) will be shown around thereof. This, in turn, will provide an easy way to find and manage the photos and videos contained the cameras (10) on the capacitive multi-touch surface (211).

The following example can be given for an application of the data communication method via touch surface. In the printing centres, there are table-shaped computers (20) comprising touch panels (21). The user places the camera (10) on the table-shaped computer (20). The camera (10) and the computer (20) communicate quickly with each other thanks to the data communication mentioned above. Then, the data is transferred to the table-shaped computer (20) through this method taking place by means of light signals or radio frequency signals initiated by this method.

In this detailed description, the additional process steps are further described for better understanding of the subject, with regard to the method of reconfiguring the graphical interface between devices.

It is imperative that the compass sensor is present on the table shaped computer and on the mobile device. It is necessary for the user to view the data on the device regularly and to rotate the graphic screen towards the user without performing a second action on the user at the location change. This will allow faster processing and better interaction with the user. Also, if multiple mobile devices are placed on the touch screen of the desktop computer, it will prevent the content from intermingling.

First of all, the second device, namely table shaped computer, has to find its own direction. The compass sensor will find out how many degrees it is facing north. The first device, namely mobile device, will make same action. When placed on the touchscreen display, the table shaped computer and the mobile device will determine their orientation (direction).

The position and orientation of the graphical interface will be rearranged according to the position and direction of the mobile devices when multiple mobile devices are located on the table shaped computer.

If only the direction of the mobile device is found, it is sufficient that only the compass sensor is present in the mobile device.

Moving the graphical interface according to the status of the mobile device will make it easier for the user. Positioning each mobile device according to its own situation will prevent confusion for multiple users.

For example, the graphical interface can be established in a certain direction of the mobile device. The user will remember when the mobile device is used again, where the graphical interface should be created on the mobile device. In addition, the user will be able to save the position and orientation as data to the mobile device for later use.

For initial use, the mobile device manufacturer can determine the position and orientation. Thus, the user will not have lived in confusion the first time. It will also prevent the graphical interface from remaining invisible under the device.

The user must place the mobile device on the touch pad of the table shaped computer. The table shaped computer is already ready to receive the signal in this case. The data signals from the mobile device begin to be sent to the table shaped computer's touch screen. The table shaped computer identifies the identity and location of the mobile device. After the handshake protocols, the two devices are connected. Then, the graphical interface starts to be created according to the characteristics of the mobile device. And the compass sensors on both devices will determine the direction of the devices at the same time. The orientation of the created graphical interface will be adjusted according to the state of the mobile device and the table shaped computer.

Only the use of the compass sensor on the mobile device will be sufficient in part.

The location of the mobile device is checked regularly. When the devices are repositioned, the mobile device's position will be found again and the compass sensor function will be automatically re-enabled.

In this detailed description, the additional process steps are further described for better understanding of the subject, with regard to a new method is applied between a first device (10), which is a stylus, and a second device (20), which is a tablet computer with capacitive multi-touch panel (21), wherein said method provides a wireless data communication between a first device (10) and a second device (20) with the mutual data signals using the negative electrical signals and the light signals, and further that these data signals are controlled and modified by means of the different sensors which are placed on one or both of the devices.

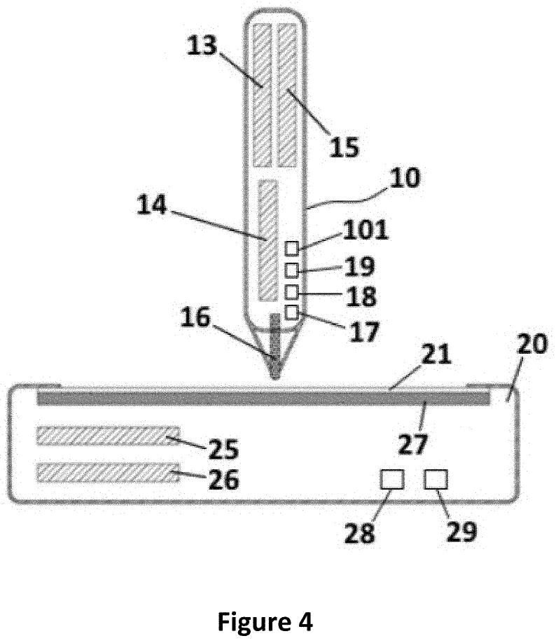

As it seen in FIG. 4, the stylus has a conductor tip (16) that affects the capacitive multi-touch panel (21) of the tablet computer. A battery is used as an electrical supply (15). And the stylus has a circuit board (14) and a processor (13) which are used for data storage and communication. And at least one light sensor (17) is used to receive the light signals from the tablet computer for wireless data communication. In addition, the first device (10) includes a pressure sensor (101) for measuring the pressure applied to the capacitive multi-touch panel (21) of the tablet computer. Further that, the first device (10) includes an inclination sensor (19) to find the angle of the tablet computer and the stylus relative to each other and further that said first device (10) includes a compass sensor (18) which controls the directional changes of the tablet computer.

The tablet computer has a capacitive multi-touch panel (21) and display units (27) under it. For more sensitive data signals, although not necessary, the tablet computer can include an inclination sensor (29) to find the angle of the stylus which moves on it. Further that, the tablet computer can include a compass sensor (28) to find the direction of the stylus which moves on it.

The wireless data communication between the stylus and tablet computer will be explained. This data communication is generated by data signals depending on whether the electricity consisting of 1 and 0 is turned on and off Data communication starts as soon as the conductor tip (16) of the stylus touches the capacitive multi-touch panel (21) of the tablet computer. The identities of the stylus and the tablet computer are transmitted to each other via mutual data signals.

Firstly, the identity of the stylus is transferred to the tablet computer by means of the negative electric signals which is created in am anner that the conductor tip (16) touchs to the capacitive multi-touch panel (21) of the tablet computer. After that, the tablet computer will send the light signals to the stylus by using the image forming units (22) and the image blanking units (23) and these light signals will be taken by the light sensor (17) of the stylus. After the mutual data signals have been transmitted, the two devices will recognize each other and mutual handshake will be ensured.

The negative electricity comes from the conductor tip (16) of the stylus where it touches the capacitive multi-touch panel (21) of the tablet computer. Said conductor tip (16) is the end point of the stylus. Negative electricity coming from the conductor tip (16) can always remain open at point 1 to generate a continuous signal. This signal will always remain on, so that the stylus can create a line or any interaction on the capacitive multi-touch panel (21) of the tablet computer. In the meantime, if the data signal is to be sent again, the data signals consisting of 1 and 0 will be transmitted to the opposite side using negative electricity. For example, while a line is drawn to the capacitive multi-touch panel (21), when the stylus is inclined slightly, the data signals will be used again to define how the new drawing will be, and said data signals will be tansmitted to the capacitive multi-touch panel (21) as data pulses.

The compass sensor (18) can vary the contents of the data signal from the stylus to the tablet computer depending on the changes in the direction of the tablet computer. For example, the angle between a graphical area (212) formed on the capacitive multi-touch panel (21) of the tablet computer and the stylus, can be adjusted. The compass sensor (18) may also affect the content of an interaction on the capacitive multi-touch panel (21) in the event that continuous negative electricity is on. For example, when the orientation of the stylus is important, different data can be sent by rotating the stylus.

The inclination sensor (19) can be used to measure the angle of the stylus relative to the tablet computer. The data comes from the stylus may vary according to the angle of the stylus. When the stylus is held upright, the data that is normal, can change the data signals transmitted from the stylus to the tablet computer when held obliquely.

Finally, the pressure sensor (101) also measures the pressure applied at the point where the stylus touches the tablet computer during the data signals transmitted to the tablet computer. According to this pressure, the data signal transmitted by the negative signals from the stylus to the tablet computer, will be differentiated according to the applied pressure.

All sensors allow the data signals from the stylus to the tablet computer to change or occur again. For example, a drawing is made on the capacitive multi-touch panel (21) of the tablet computer with the stylus, the types of the drawings can be controlled by these sensors. These data is transferred to the tablet computer by data signals and can change how the drawing will be.

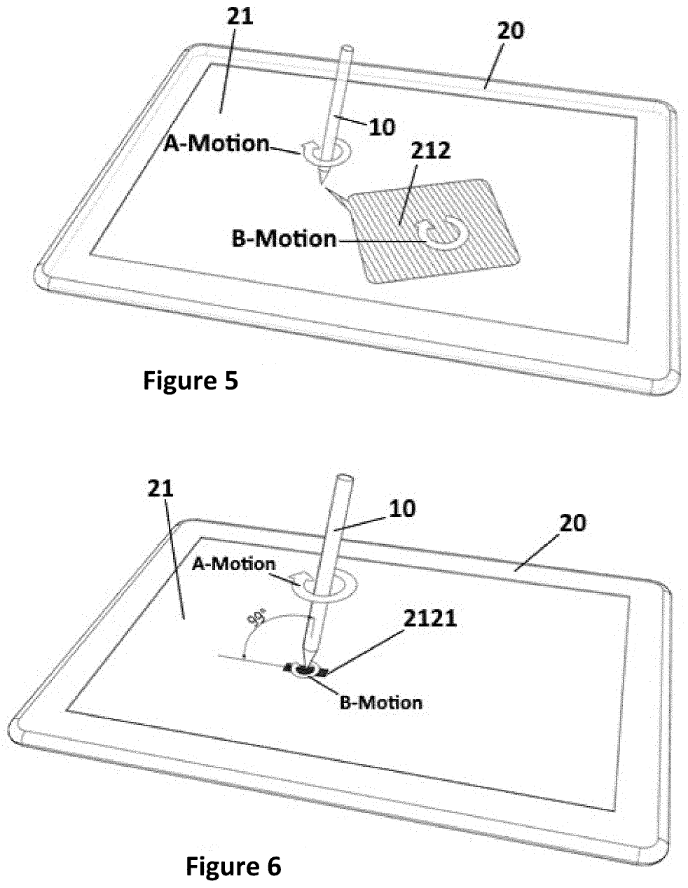

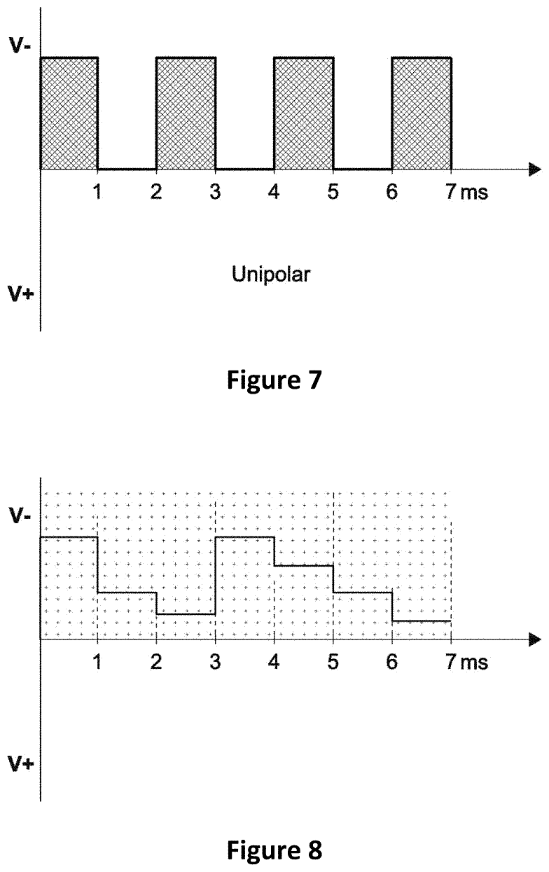

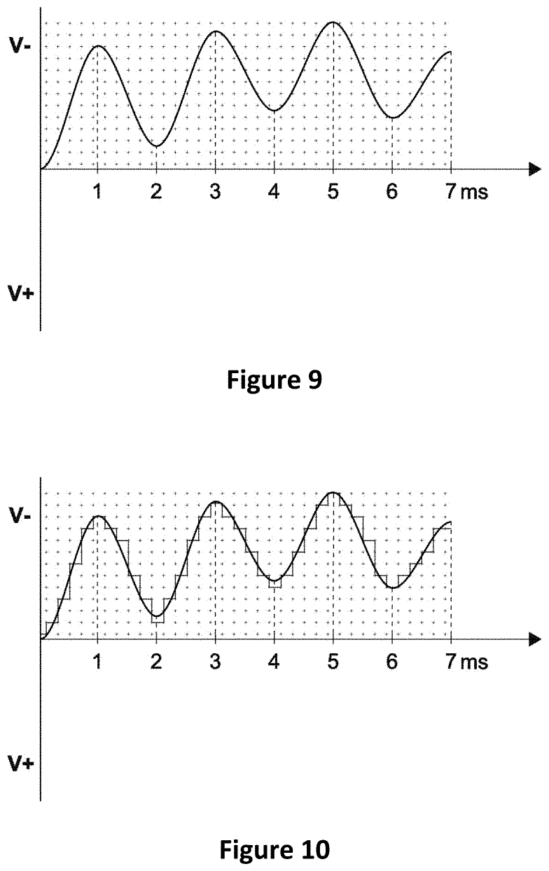

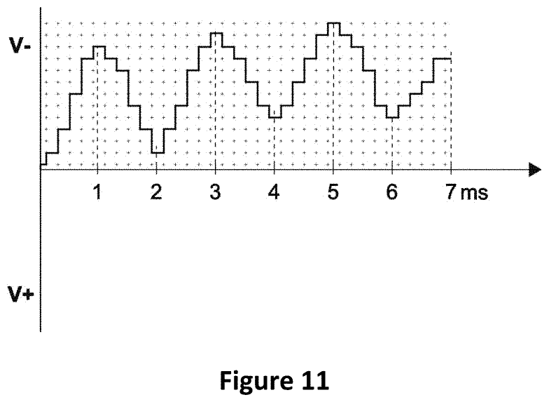

As it seen in FIG. 5, the operating principle of a compass sensor (18) on the first device (10) is described. In a preferred application of the invention, the first device (10) is a stylus and the second device (20) is a tablet computer with a capacitive multi-touch panel. Wherein said stylus performs A-Motion, B-Motion is made in the same direction in the graphic area (212) of the tablet computer. These motions (A, B) can be realized with the compass sensor (18) placed in the stylus. This can be used to enable the user to enjoy a more comfortable user experience on the tablet computer. Alternatively, a different compass sensor can also be used on the tablet computer for a more precise user experience.

FIG. 6 explains the simultaneous operation of the inclination sensor (19) and the compass sensor (18) are described. The first device (10) is a stylus and the second device (20) is a tablet computer with a capacitive multi-touch panel (21). Input chart (2121) is formed by giving the negative electricity which is continuously open to the capacitive multi-touch panel (21). The stylus forms the input chart (2121) to be used for drawing on the graphic area (212) under the capacitive multi-touch panel (21). According to this figure, a drawing or a line can be made on the graphic area (212). This figure can be supplied with various effects and shapes via the compass sensor (18) and the inclination sensor (19). The angle of the stylus to the tablet computer can be measured by the inclination sensor (19) to enlarge or change the input chart (2121). Simultaneously, the direction of the input chart (2121) can be adjusted by the compass sensor (18) of the stylus. When the stylus makes A-Motion, the input chart (2121) will make B-Motion. In addition, when the angle of movement, which is 99 degrees, comes to a different angle, the input chart (2121) can take different shapes.

It is imperative that the compass sensor is present on the table shaped computer and on the mobile device. It is necessary for the user to view the data on the device regularly and to rotate the graphic screen towards the user without performing a second action on the user at the location change. This will allow faster processing and better interaction with the user. Also, if multiple mobile devices are placed on the touch screen of the desktop computer, it will prevent the content from intermingling.

First of all, the second device, namely table shaped computer, has to find its own direction. The compass sensor will find out how many degrees it is facing north. The first device, namely mobile device, will make same action. When placed on the touchscreen display, the table shaped computer and the mobile device will determine their orientation (direction).

The position and orientation of the graphical interface will be rearranged according to the position and direction of the mobile devices when multiple mobile devices are located on the table shaped computer.

If only the direction of the mobile device is found, it is sufficient that only the compass sensor is present in the mobile device.

Moving the graphical interface according to the status of the mobile device will make it easier for the user. Positioning each mobile device according to its own situation will prevent confusion for multiple users.

For example, the graphical interface can be established in a certain direction of the mobile device. The user will remember when the mobile device is used again, where the graphical interface should be created on the mobile device. In addition, the user will be able to save the position and orientation as data to the mobile device for later use.

For initial use, the mobile device manufacturer can determine the position and orientation. Thus, the user will not have lived in confusion the first time. It will also prevent the graphical interface from remaining invisible under the device.

The user must place the mobile device on the touch pad of the table shaped computer. The table shaped computer is already ready to receive the signal in this case. The data signals from the mobile device begin to be sent to the table shaped computer's touch screen. The table shaped computer identifies the identity and location of the mobile device. After the handshake protocols, the two devices are connected. Then, the graphical interface starts to be created according to the characteristics of the mobile device. And the compass sensors on both devices will determine the direction of the devices at the same time. The orientation of the created graphical interface will be adjusted according to the state of the mobile device and the table shaped computer.

Only the use of the compass sensor on the mobile device will be sufficient in part.

The location of the mobile device is checked regularly. When the devices are repositioned, the mobile device's position will be found again and the compass sensor function will be automatically re-enabled.

A data transfer method is improved after the connection of the electronic devices (for example a tablet and a stylus) that can store information and/or generate information wherein one of the devices can transfer the data to the other device by using negative electricity with unipolar wave frequency.

The data transfer is realized after the connection of the electronic devices (for example a tablet and a stylus) that can store information and/or generate information wherein one of the devices can transfer the data to the other device by using negative electricity with unipolar wave frequency.

In order to fulfil the data transfer it is used that the analog and/or digital coding in this unipolar wave frequency depending on the type of data. The second device can receive modulated data at this frequency used at the point where the first device touches the touch surface of the second device. The frequency can be transmitted by negative electrical pulses, wherein the data being encoded with on/off and/or voltage changes.

At the point where the first device touches the touch surface of the second device is a conductive end. With this conductive end, data signals are sent from the first device to the second device. It is likewise possible to measure negative electricity on the touch surface by the first device.

Therefore, it is possible to transmit data from the second device to the first device by the same technique. Again at this point, data can be transmitted to the counter device over the same frequency. This frequency can also be used as a unipolar wave to use only negative electricity. Analog and/or digital coding may be used depending on the type of data at this unipolar wave frequency. The first device (for example a stylus) can receive the data modulated by measuring the negative electricity at the frequency used at the point where the first device touches the touch surface of the second device. The frequency can be transmitted by negative electrical pulses, wherein, data being encoded with on-off and/or voltage changes.

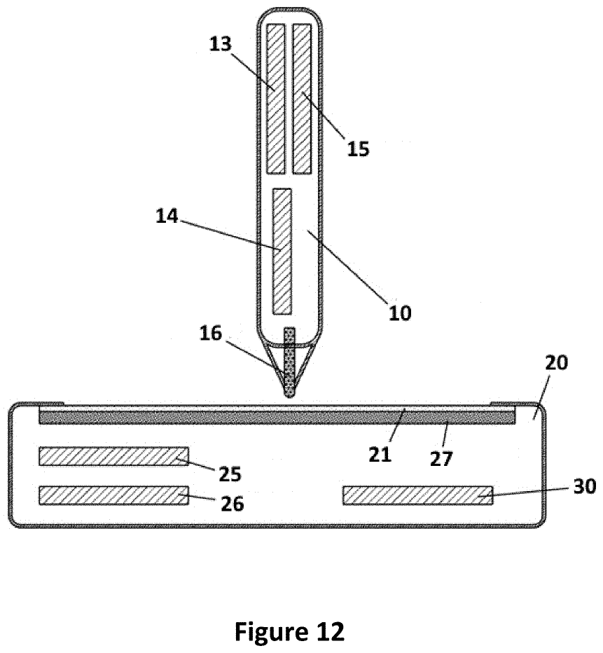

As it seen in FIG. 12, the first device comprises an electrical source, a processor for generating information, a circuit board used to frequency the digital data generated by the electrical source and a conductor tip. The second device includes an electrical source, a processor for generating information, a capacitive touchpad used to understand touches on a touch surface and to transmit digital data generated by the processor and the electrical supply, display units used to generate images, as well as a circuit board that transmits data by frequency to the touchpad. When the touchpad detects touch points, it may be used to transmit data to the point at which the conductor end of the first device touches, transmitting the encoded frequency.

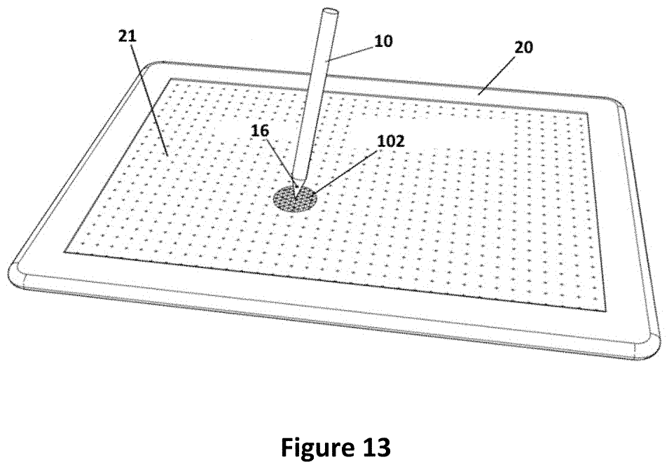

As it seen in FIG. 13, the first device is a stylus and the second device is a tablet computer. In order to provide mutual data transfer, the stylus has a conductor tip and the tablet compouter has a capacitive multi-touch panel. On the touchpad, to send data from the tablet to the stylus, it is seen that the dedicated capacitive area on the capacitive multi-touch panel that corresponds to the bottom of the stylus, wherein, at the point where it touches the capacitive multi-touch panel.

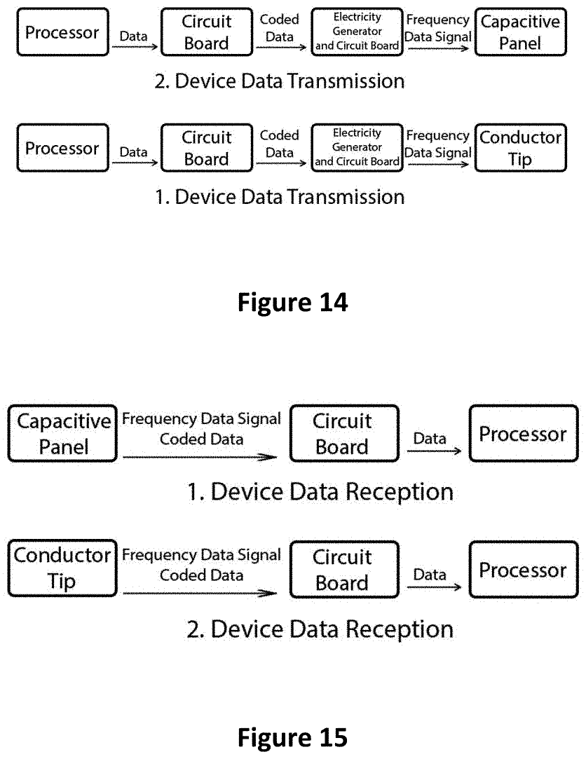

FIG. 14 is a representational algorythm of the processes that devices use to transmit data to the other device.

FIG. 15 is a representational algorythm of the processes that devices use to receive data from the sending device.

I claim:

1. A method of data communication via a touch surface such as to enable wireless data communication between a first device and a second device, the method comprising:
turning on the first device and the second device, the first device capable of data generation and/or data storage, the second device capable of data generation and/or data storage, said second device is electrically contacted with a capacitive multi-touch panel with a capacitive multi-touch surface;
wherein the method further comprises
turning on the first device and sending the signal to a conductor tip;
placing the first device on the capacitive multi-touch surface contacted with the second device;
sending the signals defining the identification and position information of the first device on the capacitive multi-touch surface by the conductor tip;
receiving the signals sent by the conductor tip on the capacitive multi-touch surface; and
sending of the information from the second device to the first device, containing the confirmation that the identity and location of the first device is received and it is ready to receive data; and
transferring the data after the connection of the first device and the second device that can store information and/or generate information, wherein one of the devices can transfer the data to the other device by using negative electricity with unipolar wave frequency.

2. The method of claim 1, wherein the data is transferred by using capacitive multi-touch panel from the first device to the second device by negative electric signals with unipolar wave frequency or from the second device to the first device by negative electric signals with unipolar wave frequency.

3. The method of claim 1, wherein the data is transferred by using the analog and/or digital coding in said unipolar wave frequency depending on the type of data.

4. The method of claim 1, wherein the second device can receive modulated data at said frequency used at the point where the first device touches the touch surface of the second device.

5. The method of claim 1, wherein the frequency can be transmitted by negative electrical pulses, wherein the data being encoded with on/off and/or voltage changes.

6. The method of claim 1, wherein the first device is a stylus with a conductor tip and the second device is a tablet computer with a capacitive multi-touch panel, the data is sent from the tablet computer to the stylus by means of a dedicated capacitive area on the capacitive multi-touch panel that corresponds to the bottom of the stylus, wherein it touches the capacitive multi-touch panel.
